(19) United States
(12) Patent Application Publication
(10) Pub. No.: US 2006/0084739 A1
(43) Pub. Date: Apr. 20, 2006

(54) Labeled polymer dispersion and adhesives obtained therefrom

(76) Inventors: Bernhard Gruenewaelder, Hilden (DE); Thomas Empt, Viersen (DE); Birgit Ness, Langenfeld (DE); Horst Beck, Neuss (DE)

Correspondence Address: HENKEL CORPORATION, THE TRIAD, SUITE 200, 2200 RENAISSANCE BLVD., GULPH MILLS, PA, 19406, US

(21) Appl. No.: 11/284,614

(22) Filed: Nov. 22, 2005

Related U.S. Application Data
(63) Continuation of application No. PCT/EP04/05602, filed on May 25, 2004.

(30) Foreign Application Priority Data
May 27, 2003 (DE) 103 24 086.1

(51) Int. Cl. C08K 3/22

(52) U.S. Cl. 524/413

(57) ABSTRACT

Polymer dispersions containing water, at least one water-dispersible polymer, and at least two ions or elements selected from the group consisting of Li, Ba, Sr, B, Co, Cu, Mn, Mo, Ni, Ag, Pb, Zn, W, La, Ce and Sn or salts thereof. The ions or elements are present in the dispersion in amounts of at least 10 ppm.

### CROSS REFERENCE TO RELATED APPLICATIONS

This application is a continuation under 35 U.S.C. § 365(c) and 35 U.S.C. § 120 of international application PCT/EP2004/005602, filed May 25, 2004. This application also claims priority under 35 U.S.C. § 119 of DE 103 24 086.1, filed May 27, 2003, which is incorporated herein by reference in its entirety.

### BACKGROUND OF THE INVENTION

This invention relates to a polymer dispersion containing water, at least one polymer obtainable by emulsion polymerization, and at least two ions or elements selected from the group consisting of Li, Ba, Sr, B, Co, Cu, Mn, Mo, Ni, Ag, Pb, Zn, W, La, Ce or Sn or at least one salt of at least two such elements.

The use of adhesives in the manufacture of industrial goods is increasingly replacing mechanical fastenings, particularly in cases where the joint between two workpieces is exposed to only moderate loads. The advantage of using adhesives for establishing mechanical bonds lies particularly in the simple use of the adhesives, in the possibility of joining materials continuously and, if desired, over entire surfaces, and in the high strength of modern adhesives as used, for example, in the furniture industry or in the vehicle industry.

Dispersion adhesives containing water-dispersible polymers of the type obtainable, for example, by emulsion polymerization of ethylenically unsaturated monomers in aqueous phase are commonly used in those fields. However, with the increasing use of adhesives in the production of high-quality articles, the quality of the adhesives themselves is also becoming more important. Above all in the manufacture of high-quality furniture, manufacturers depend on the adhesives used meeting all the required standards, so that pieces of furniture have no quality defects attributable to inferior adhesives. If an adhesive bond does not satisfy the quality demands it is expected to meet, the search for the cause of this problem is often very difficult. In particular, proving that an adhesive of the required standard was actually used has hitherto proved extremely problematic. Manufacturers of high-quality adhesives in particular were frequently faced with the problem that inferior adhesives marketed by imitators could only be identified at considerable cost after the completion of a bond.

In order to tackle this problem, fluorescent markers, for example, are added to adhesives. This is supposed to ensure that a bond can even be subsequently examined to determine whether it was carried out using the intended adhesive.

The problem of this approach is that the number of adhesives containing fluorescent markers is now so large that clear identification and classification of the adhesives is no longer possible. In addition, the relatively non-specific feature of “fluorescence” makes it difficult to prosecute product pirates because identification of the actual source of the fluorescence and hence the compound used as marker is extremely difficult.

Suppliers of adhesives generally have a broad product portfolio encompassing several types of adhesives with very different property profiles. In recent years in particular, adhesive manufacturers have started to offer adhesive types with property profiles optimized for a particular application. Whereas a particular adhesive type may have excellent properties for its intended application, the same adhesive used for another application, for example on an unsuitable substrate or in unsuitable ambient conditions, can be so unsuitable in its adhesive strength that a corresponding bond no longer has the claimed properties. Accordingly, even the unauthorized substitution of adhesive types within the product range of an adhesive manufacturer can lead to problems that demand a knowledge of the adhesive type used if they are to be resolved and eliminated.

In addition, a disadvantage of the organic markers known from the prior art is that they can decompose under the influence of ambient conditions, such as light, oxygen, temperature and the like, or by reaction with one or more ingredients of the adhesive, so that they may not be available for proof.

Hitherto unpublished German patent application 101 58 839.9 relates to a process for marking a dispersion adhesive with an element selected from the group consisting of Li, B, Co, Cu, Mo, Ni, Pb or Sn and to dispersion adhesives thus marked. The above-described marking can be carried out without difficulty by this process. However, a problem is that, due to the limited number of elements available overall for such a marking process, it is not possible to distinguish between the large number of adhesives within the product portfolio of an adhesive supplier. In addition, the limitations of the marking method described in the above-cited patent application, for example where it is applied to metal substrates, can be shown up if, for example, the element used for marking is present in the corresponding substrate.

DE 195 48 038 A1 and DE 199 00 459 A1 relate to polymer dispersions which can be produced using metal-containing catalysts.

Accordingly, the problem addressed by the present invention was to provide a polymer dispersion that would allow unequivocal attribution to its manufacturer. Another problem addressed by the present invention was to provide a polymer dispersion that would allow attribution to its manufacturer in a simple manner. A further problem addressed by the invention was to provide a polymer dispersion that would allow attribution to its manufacturer, even within a broad product portfolio of that manufacturer. Yet another problem addressed by the present invention was to provide a polymer dispersion that would allow the adhesive to be identified even after substantial degradation of the adhesive matrix.

The problems stated above have been solved by a polymer dispersion containing water, at least one water-dispersible polymer and at least two ions or elements selected from the group consisting of Li, Ba, Sr, B, Co, Cu, Mn, Mo, Ni, Ag, Pb, Zn, W, La, Ce or Sn.

### DESCRIPTION OF THE INVENTION

Accordingly, the present invention relates to a polymer dispersion containing water, at least one water-dispersible polymer and at least two elements selected from the group consisting of Li, Ba, Sr, B, Co, Cu, Mn, Mo, Ni, Ag, Pb, Zn, W, La, Ce or Sn or at least two salts selected from the group of salts of the elements Li, Ba, Sr, B, Co, Cu, Mn, Mo, Ni, Ag, Pb, Zn, W, La, Ce or Sn, at least two of the salts containing a different ion selected from the group consisting of the ions of the elements Li, Ba, Sr, B, Co, Cu, Mn, Mo, Ni, Ag, Pb, Zn, W, La, Ce or Sn and the total quantity of ions or elements selected from the above-mentioned group amounting to at least 10 ppm.

The letters “ppm” in the present specification relate to the weight of the corresponding compounds, elements, ions and compositions, unless otherwise expressly stated.

In the context of the present invention, a “polymer dispersion” is understood to be a dispersion of polymer particles in water. The size of the polymer particles is in the range typically observed where polymerizations are carried out by emulsion polymerization. Exemplary particle sizes for the purposes of the present invention are in the range from ca. 0.001 to ca. 0.2 mm.

The expression “water-dispersible.” in the context of the present invention applies, for example, to all polymers which are self-dispersible in water, i.e. which form a stable dispersion in water or a water-containing environment in the absence of emulsifiers or in the presence of only small quantities of emulsifiers, for example of up to ca.1 or up to ca. 0.5% by weight or up to ca. 0.2% by weight or less. Suitable polymers are, for example, polymers which contain a sufficient number of hydrophilic groups, for example quaternary amino groups, carboxyl groups or polyether groups. The expression “water-dispersible” as used in the present specification also encompasses polymers which are not self-dispersible in water, but form stable dispersions in water with the aid of emulsifiers. Such polymers include, for example, polymers which can be produced by emulsion polymerization.

The polymer dispersions according to the invention may contain water from any source. For example, the water used in the polymer dispersions according to the invention may be tap water of the type generally obtainable from corresponding supply sources. However, ground water, industrial water, process water or water recovered in some other form from a circuit may equally well be used in the polymer dispersions according to the invention, providing the pH and the salt content allow stable polymer dispersions to be sustained.

The polymer dispersions may be produced, for example, using olefinically unsaturated monomers which lend themselves to emulsion polymerization. Suitable polymers for the production of the dispersions according to the invention are, for example, vinyl ester polymers of which the basic monomeric unit is a vinyl ester of a linear or branched carboxylic acid containing ca. 2 to ca. 44 carbon atoms, for example ca. 3 to ca. 15 carbon atoms. Suitable monomers for these homopolymeric or polymeric polyvinyl esters are vinyl formate, vinyl acetate, vinyl propionate, vinyl isobutyrate, vinyl pivalate, vinyl-2-ethyl hexanoate, vinyl esters of saturated, branched monocarboxylic acids containing 9 to ca. 15 carbon atoms in the acid component, vinyl esters of relatively long-chain, saturated or unsaturated fatty acids, such as vinyl laurate, vinyl stearate, or vinyl esters of benzoic acid and substituted derivatives of benzoic acid, such as vinyl p-tert.butyl benzoate. The vinyl esters mentioned may be present in the polyvinyl ester either individually or in the form of mixtures of two or more of the vinyl esters mentioned. In a preferred embodiment of the invention, the percentage content of these vinyl esters in the polymer as a whole is at least ca. 50% by weight, for example at least ca. 75% by weight.

In another preferred embodiment of the present invention, polymers which contain other comonomers besides one of the above-mentioned vinyl esters or a mixture of two or more of the above-mentioned vinyl esters may also be present in the polymer dispersion. Other ethylenically unsaturated monomers which may be copolymerized with the above-mentioned vinyl esters are, for example, acrylic acid, methacrylic acid and esters thereof with primary and secondary, saturated monohydric alcohols containing 1 to ca. 28 carbon atoms, such as methanol, ethanol, propanol, butanol, 2-ethylhexyl alcohol, cycloaliphatic alcohols, such as cyclohexanol, hydroxymethyl cyclohexane or hydroxyethyl cyclohexane. Esters of the above-mentioned ethylenically unsaturated acids with relatively long-chain fatty alcohols are also suitable comonomers, as are ethylenically unsaturated dicarboxylic acids, such as maleic acid, fumaric acid, itaconic aid or citraconic acid and monoesters and diesters thereof with saturated monohydric aliphatic alcohols containing 1 to ca. 28 carbon atoms. The percentage content of such comonomers in the polymers present in the polymer dispersion according to the invention may be up to ca. 25% by weight, for example ca. 0.1 to ca. 15% by weight.

Other suitable comonomers are monoethylenically unsaturated hydrocarbons, such as ethylene or α-olefins containing ca. 3 to ca. 28 carbon atoms, for example propylene, butylene, styrene, vinyl toluene, vinyl xylene, and halogenated unsaturated aliphatic hydrocarbons, such as vinyl chloride, vinyl fluoride, vinylidene chloride, vinylidene fluoride and the like. The percentage content of such comonomers as these in the polymers used in the dispersions according to the invention may be up to ca. 50% by weight or less, for example ca. 0.5 to ca. 25% by weight.

Other comonomers suitable for use in accordance with the invention are, for example, polyethylenically unsaturated monomers. Examples of such monomers are diallyl phthalates, diallyl maleate, triallyl cyanurate, tetraallyloxyethane, divinyl benzene, butane-1,4-diol dimethacrylate, triethylene glycol dimethacrylate, divinyl adipate, allyl acrylate, allyl methacrylate, vinyl crotonate, methylene-bis-acrylamide, hexanediol diacrylate, pentaerythritol diacrylate or trimethylol propane triacrylate or mixtures of two or more thereof. The percentage content of comonomers such as these in the polymers produced by emulsion polymerization present in the dispersions according to the invention is up to ca. 10% by weight, for example ca. 0.01 to ca. 5% by weight.

Other suitable comonomers are ethylenically unsaturated compounds containing N-functional groups. Such compounds include, for example, acrylamide, methacrylamide, allyl carbamate, acrylonitrile, N-methylol acrylamide, N-methylol methacrylamide, N-methylol allyl carbamate and the N-methylol esters, alkylethers or Mannich bases of N-methylol acrylamide or N-methylol methacrylamide or N-methylol allyl carbamate, acrylamidoglycolic acid, acrylamidomethoxyacetic acid methyl ester, N-(2,2-dimethoxy-1-hydroxyethyl)-acrylamide, N-dimethylaminopropyl acrylamide, N-dimethylaminopropyl methacrylamide, N-methyl acrylamide, M-methyl methacrylamide, N-butyl acrylamide, N-butyl methacrylamide, N-cyclohexyl acrylamide, N-cyclohexyl methacrylamide, N-dodecyl acrylamide, N-dodecyl methacrylamide, ethyl imidazolidone methacrylate, N-vinyl formamide, N-vinyl pyrrolidone and the like.

Other organic polymers suitable in accordance with the invention for the production of the polymer dispersions belong to the group of styrene/butadiene rubbers (SBRs). Such rubbers are produced by copolymerization of styrene and butadiene and generally contain the two monomers in a ratio by weight of ca. 23.5 to 76.5 or ca. 40 to 60. The SBRs are normally produced by emulsion polymerization in water.

Another group of polymers are the polyvinyl acetates (PVACs). The polyvinyl acetates are thermoplastic polymers of vinyl acetate. The polymerization is generally carried out by suspension or emulsion polymerization.

Another suitable group of polymers are the polyethylene homo- and copolymers. A radical polymerization of ethylene is carried out, for example, in the course of high-pressure polymerization to LDPE under pressures of ca. 1,400 to 3,500 bar and at temperatures of 150 to 350° C. The reaction is initiated by oxygen or peroxides. Suitable comonomers are linear or branched α,β-unsaturated olefins.

Another group of suitable polymers are the polyacrylates or the methacrylates or copolymers of polyacrylates and polymethacrylates. The polymers mentioned may optionally contain small percentages (up to ca. 10%) of free acrylic acid or methacrylic acid groups.

Another suitable polymer is polyvinylidene chloride. The polymer is preferably obtained by emulsion polymerization of 1,1-dichloroethylene. Copolymers of 1,1-dichloroethylene with acrylates, methacrylates, vinyl chloride or acrylonitrile are particularly suitable.

Another suitable polymer is polyvinylidene fluoride. The polymer can be obtained by polymerization of vinylidene fluoride and can be adapted in its chemical and mechanical properties, for example by copolymerization with suitable monomers, such as ethylene, acrylonitrile, acrylate esters, methacrylate esters and the like.

The polyvinyl chlorides obtainable by emulsion polymerization (E-PVC) are also suitable.

According to the invention, the polymers mentioned may be present in the polymer dispersion according to the invention both individually and in the form of a mixture of two or more thereof.

In a preferred embodiment of the invention, a copolymer of vinyl acetate and ethylene (EVA copolymer) is used as the organic polymer. In another preferred embodiment of the invention, the polymer dispersion contains polyvinyl acetate or polyacrylate, more particularly polybutyl acrylate or a mixture of polyvinyl acetate and polyacrylate.

The polymer dispersion according to the invention contains the above-mentioned polymers obtainable by emulsion polymerization in a quantity of at least ca. 30% by weight. In a preferred embodiment of the present invention, the percentage content of such polymers is at least ca, 35% by weight or at least ca. 40% by weight. However, it may be even higher, for example at least ca. 45% by weight or at least ca, 50% by weight or higher, for example at least ca. 55% by weight or at least ca. 60% by weight.

A polymer dispersion according to the invention additionally contains at least two elements selected from the group consisting of Li, Ba, Sr, B, Co, Cu, Mn, Mo, Ni, Ag, Pb, Zn, W, La, Ce or Sn or at least two salts selected from the group of salts of the elements Li, Ba, Sr, B, Co, Cu, Mn, Mo, Ni, Ag, Pb, Zn, W, La, Ce or Sn, at least two of the salts containing a different ion selected from the group consisting of the ions of the elements Li, Ba, Sr, B, Co, Cu, Mn, Mo, Ni, Ag, Pb, Zn, W, La, Ce or Sn.

In the present specification, the term “elements” applies to the elements mentioned above in their elemental form, i.e. to the corresponding metals. Such metals may be present in the polymer dispersions according to the invention in virtually any form providing a sufficiently uniform distribution of the metals in the dispersion or in the resulting adhesive, as determined by sampling, is guaranteed.

Corresponding metals are advantageously used in the form of fine particles, i.e. as particles with a very small particle size, for example as microparticles or as nanoparticles.

In a particularly advantageous embodiment, however, the corresponding elements are used in the form of their salts, more particularly in the form of their water-soluble salts. If water-insoluble or only partly water-soluble salts are used, these salts should be used, for example as microparticles, nanoparticles or corresponding micro- or nanocolloids in accordance with the foregoing observations. However, a particularly good distribution of the salts is guaranteed when the salts used are soluble in water. The term “water-soluble” applies to the solubility of the salts in water or an aqueous polymer dispersion.

Accordingly, in a preferred embodiment of the invention, a polymer dispersion according to the invention contains at least two water-soluble salts selected from the group of water-soluble salts of the elements Li, Ba, Sr, B, Co, Cu, Mn, Mo, Ni, Ag, Pb, Zn, W, La, Ce or Sn, at least two or the water-soluble salts containing a different ion selected from the group consisting of the ions of the elements Li, Ba, Sr, B, Co, Cu, Mn, Mo, Ni, Ag, Pb, Zn, W, La, Ce or Sn.

The term “different ion” as used in the present specification does not apply to ions of an element which may be present, for example, in different states of ionization, but rather to ions of different elements selected from the above-mentioned group. The term encompasses both anions and cations providing the above-mentioned elements may be present as anionic complexes, as is the case with Mo for example.

Accordingly, a polymer dispersion according to the invention may contain, for example, the following combinations of elements or ions: Li and Ba, Li and Sr, Li and B, Li and Co, Li and Cu, Li and Mn, Li and Mo, Li and Ni, Li and Ag, Li and Pb, Li and Zn, Li and W, Li and La, Li and Ce, Li and Zn, Ba and Sr, Ba and B, Ba and Co, Ba and Cu, Ba and Mn, Ba and Mo, Ba and Ni, Ba and Ag, Ba and Pb, Ba and Zn, Ba and W, Ba and La, Ba and Ce, Ba and Zn, Sr and B, Sr and Co, Sr and Cu, Sr and Mn, Sr and Mo, Sr and Ni, Sr and Ag, Sr and Pb, Sr and Zn, Sr and W, Sr and La, Sr and Ce, Sr and Zn, B and Co, B and Cu, B and Mn, B and Mo, B and Ni, B and Ag, B and Pb, B and Zn, B and W, B and La, B and Ce, B and Zn, Co and Cu, Co and Mn, Co and Mo, Co and Ni, Co and Ag, Co and Pb, Co and Zn, Co and W, Co and La, Co and Ce, Co and Zn, Cu and Mn, Cu and Mo, Cu and Ni, Cu and Ag, Cu and Pb, Cu and Zn, Cu and W, Cu and La, Cu and Ce, Cu and Zn, Mn and Mo, Mn and Ni, Mn and Ag, Mn and Pb, Mn and Zn, Mn and W, Mn and La, Mn and Ce, Mn and Zn, Mo and Ni, Mo and Ag, Mo and Pb, Mo and Zn, Mo and W, Mo and La, Mo and Ce, Mo and Zn, Ni and Ag, Ni and Pb, Ni and Zn, Ni and W, Ni and La, Ni and Ce, Ni and Zn, Ag and Pb, Ag and Zn, Ag and W, Ag and La, Ag and Ce, Ag and Zn, Pb and W, Pb and La, Pb and Ce, Pb and Zn, W and La, W and Ce, W and Zn, La and Ce, La and Zn and Ce and Zn.

A polymer dispersion according to the invention may of course also contain combinations of three or more, for example 4, 5, 6, 7, 8 or 9, different elements or ions or mixtures of the elements or ions listed in the present specification as part of the polymer dispersions according to the invention.

In a preferred embodiment, a polymer dispersion according to the invention may contain two, three or four, more particularly two or three, different elements or ions or mixtures of the elements and ions listed in the foregoing.

In a rather preferred embodiment, a polymer dispersion according to the invention contains at least Li or Li ions, Sr or Sr ions, Sn or Sn ions or Mo or Mo ions, more particularly Li ions or Sn ions.

In another advantageous embodiment of the invention, the different elements or different ions present in a dispersion are present in a particular ratio. Basically, it does not matter what that ratio actually is providing it is within a particular range for a certain type of adhesive so as to enable that adhesive type to be identified. However, the quantity of an element or ion in a polymer dispersion according to the invention should at least be selected so that the element or the ion can be detected by standard methods of detection, for example by MS or ICP, for example ICP-OES or ICP-MS.

If a polymer dispersion according to the invention contains, for example, two of the above-mentioned elements or ions, the ratio of the two elements or ions to one another may be, for example, ca. 100:1 to ca. 1:100. In a preferred embodiment of the present invention, the ratio between two different elements or ions is selected so that it is in a range of ca. 50:1 to ca. 1:50, for example ca. 40:1 to ca. 1:40 or ca. 30:1 to ca. 1:30 or ca. 20:1 to ca. 1:20 or ca. 10:1 to ca. 1:10 or ca. 5:1 to ca. 1:5, for example ca. 4:1 to ca. 1:4 or ca. 3:1 to ca. 1:3 or ca. 2:1 to ca. 1:2 or ca. 1:1.

In many cases, it has proved to be effective to use one of the elements, for example, as a “lead element” and to use another element or two or more other elements in small quantities. This can result, for example, in ratios of elements or ions which lie in a range of ca. 50:1 to ca. 1:1, for example ca. 40:1 to ca. 1:1 or ca. 30:1 to ca. 1:1 or ca. 20:1 to ca. 1:1 or ca. 10:1 to ca. 1:1 or ca. 5:1 to ca. 1:1, for example ca. 4:1 to ca. 1:1 or ca. 3:1 to ca. 1:1 or ca. 2:1 to ca. 1:1.

If three or more elements or ions are used to mark a polymer dispersion according to the invention, the individual elements or ions may also be used in virtually any ratios with the above-mentioned provisos regarding their detectability.

Accordingly, the present invention creates the possibility of a marking system which in turn creates a virtually unlimited number of possibilities for marking polymer dispersions through the selected elements or ions themselves, through the number of elements or ions and through the ratios of the individual ions or elements to one another.

According to the invention, the total quantity of elements selected from the above-mentioned group is at least about 10 ppm.

In another particularly advantageous embodiment, the total quantity of the elements mentioned above is in a range from about 15 to about 800 ppm, for example in a range from about 20 to about 400 ppm. Suitable lower limits for the content of the elements or ions mentioned above are, for example, ca. 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195 or 200 ppm. Suitable upper limits are, correspondingly, ca. 390, 380, 370, 360, 350, 345, 340, 335, 330, 325, 320, 315, 310, 305, 300, 295, 290, 285, 280, 275, 270, 265, 260, 255, 250, 250, 254, 240, 235, 230, 225, 220, 215, 210 or 205 ppm, the upper and lower limits mentioned being combinable virtually as required.

It is important in the present case that the elements and compounds used for marking are not a natural constituent of the substrate (for example wood) to be glued or of typical gluing adhesives in a quantity significantly exceeding the marking quantity. In order to establish this, for example for furniture making, samples of woods varying in origin as typically used for making furniture were analyzed for their content of various elements.

| Element [mg/kg] | Pine | Oak | Meranti | Teak |
|---|---|---|---|---|
| Li | <1 | <1 | <1 | <1 |
| B | 1 | 3 | 2 | 3 |
| Ba | 5 | 12 | 21 | 2 |
| Ca | 550 | 670 | 2300 | 1200 |
| Cd | <1 | <1 | <1 | <1 |
| Co | <1 | <1 | <1 | <1 |
| Cr | <1 | <1 | <1 | <1 |
| Cu | <1 | 1 | 1 | 3 |
| Fe | 4 | 4 | 5 | 2 |
| Mg | 130 | 79 | 160 | 870 |
| Mo | <1 | <1 | <1 | <1 |
| Ni | <1 | <1 | <1 | <1 |
| P | 6 | 7 | 10 | 790 |
| Pb | <1 | <1 | 1 | <1 |
| Sn | <1 | <1 | 1 | <1 |
| V | <1 | <1 | <1 | <1 |
| Zn | 7 | <1 | 4 | <1 |

This shows that the elements used for marking in accordance with the present invention normally occur in only small quantities, if at all, in a natural environment, i.e. in the present case in the wood to be glued.

Accordingly, the present invention enables an adhesive to be clearly marked with a view to its intended application, for example based on the surface of the substrate to be glued. Even if an unknown substrate contains an element used for marking in an unexpectedly large quantity, a second element used for marking still remains to allow rapid and at least provisional identification. Closer identification is then possible, for example by determining the content of that element in the substrate and subtracting this value from the value measured in the adhesive.

In a preferred embodiment of the present invention, the above-mentioned elements are present in the polymer dispersion according to the invention in the form of their inorganic or organic salts, i.e. in ionized form. Basically, suitable anions for the corresponding salts are any anions which do not adversely affect the properties of the polymer dispersion. Compounds containing non-toxic anions are preferably used. In a preferred embodiment of the present invention, the salts used are, in particular, chlorides or nitrates of the above-mentioned elements. In another preferred embodiment of the present invention, lithium chloride is used for marking a polymer dispersion according to the invention.

Basically, analysis techniques suitable for detecting the elements mentioned are any of the techniques which allow those elements to be detected to a lower limit of ca. 1 ppm or less. The techniques known to the expert as AAS (atomic absorption spectroscopy) and ICP (inductive coupled plasma) are particularly suitable.

Besides the water-dispersible organic polymers mentioned thus far, the polymer dispersion according to the invention may contain at least one protective colloid or a mixture of two or more protective colloids. Suitable protective colloids are, for example, etherified cellulose derivatives, such as hydroxyethyl cellulose, hydroxypropyl cellulose or carboxymethyl cellulose. Other suitable protective colloids are polyvinyl pyrrolidone or polycarboxylic acids, such as polyacrylic acid or polymethacrylic acid, optionally in the form of their copolymers with optionally OH-functional esters of acrylic or methacrylic acid, and copolymers of maleic acid or maleic anhydride with other ethylenically unsaturated compounds, such as methylvinylether or styrene. In a preferred embodiment of the present invention, however, polyvinyl alcohol, for example polyvinyl alcohol with a degree of hydrolysis of ca. 30 to ca. 100% by weight, for example ca. 60 to ca. 98% by weight or ca. 70 to ca. 88% by weight, or a mixture of two or more such polyvinyl alcohols is used as the protective colloid. As described above, the protective colloids suitable for use in the polymer dispersions according to the invention may be used individually. However, a mixture of two or more of the protective colloids mentioned may equally well be used.

In a preferred embodiment of the present invention, a polymer dispersion according to the invention contains a protective colloid bearing OH groups. In another preferred embodiment of the present invention, the polymer dispersion contains polyvinyl alcohol as the protective colloid.

The total percentage content of protective colloid(s) in the polymer dispersion according to the invention as a whole is ca. 0 to ca. 20% by weight, for example ca. 0.5 to ca. 15 or ca. 1 to ca. 10% by weight.

In addition, the polymer dispersion according to the invention may contain a water-soluble acidic metal salt to improve water resistance. Suitable metal salts are, for example, the nitrates, chlorides, oxychlorides or sulfates of aluminium, iron, chromium, titanium, zirconium or vanadium. In a preferred embodiment of the present invention, the salts of aluminium, chromium or zirconium in particular are used, examples of such salts being aluminium chloride, aluminium nitrate, chromium chloride or zirconium oxychloride. The acidic metal salts mentioned may be used individually or in the form of mixtures of two or more thereof for the purposes of the invention.

The corresponding salts are used in a quantity of ca. 0.05 to ca. 20% by weight, for example in a quantity of ca. 0.1 to ca. 10% by weight or ca. 0.2 to ca. 5% by weight, based on the polymer dispersion as a whole. A solution of the corresponding metal salts is advantageously stirred into the polymer dispersion.

In a preferred embodiment of the invention, the corresponding metal salt or a mixture of two or more of the corresponding metal salts is added in such a quantity that the polymer dispersion has a pH of ca. 1 to ca. 5. In another preferred embodiment of the invention, the polymer dispersion has a pH of ca. 2 to ca. 4.

If the pH of the polymer dispersion is to remain stable over a prolonged period, it has proved to be of advantage to add a buffer system to the polymer dispersion. Suitable buffer systems for the dispersion are, for example,
carbonate/hydrogen carbonate
sodium acetate/acetic acid,
monopotassium citrate (KH₂ citrate),
monosodium phosphate/citric acid.

Besides the constituents already mentioned, the polymer dispersion according to the invention may also contain a crosslinker resin or a mixture of two or more crosslinker resins. Crosslinker resins suitable for the purposes of the invention are, for example, phenol/formaldehyde resins or 1,3-dimethylol-4,5-dihydroxyimidazolidone (4,5-dihydroxy-N,N′-dimethylolethylene urea) or dihydroxymethyl ethylene urea, dihydroxymethyl propylene urea or dihydroxymethyl urone or thio derivatives or self-condensation products thereof or mixtures of two or more thereof. Suitable phenol/formaldehyde resins can be obtained by reacting phenol or phenol derivatives and formaldehyde or formaldehyde derivatives together with an increase in molecular weight. In a preferred embodiment of the invention, phenol/formaldehyde resins suitable for the purposes of the invention have a softening point (ring-and-ball) after crosslinking of ca. 80 to ca. 130° C., for example in the range from ca. 90 to ca. 120° C.

Phenol/formaldehyde resins suitable for the purposes of the invention have OH groups at the aromatic phenol units. For example, phenol/formaldehyde resins with an OH value of 100 or less, for example ca. 80, ca. 60 to ca. 40 or lower, for example ca. 20 or ca. 10, may be used. Suitable phenol/formaldehyde resins contain, for example, less than 10% by weight free methyl groups, for example less than 8% by weight, less than 6% by weight or less than 4% by weight or less. Suitable phenol/formaldehyde resins are self-dispersible in water and, as a dispersion, remain stable for prolonged periods, for example for 4 weeks or more.

Phenol/formaldehyde resins of which the phenol units are substituted in the p-position to the OH group may also be used for the purposes of the invention. Suitable substituents are, for example, linear or branched, saturated or unsaturated alkyl chains containing 1 to ca. 22 carbon atoms. The phenol/formaldehyde resins suitable for the purposes of the invention are normally marketed as aqueous emulsions with a solids content of up to ca. 60% by weight. Another preferred embodiment of the present invention is characterized by the use of emulsions which have a viscosity of ca. 50 to ca. 100 poises for a solids content of ca. 45 to ca. 55% by weight and a pH value of ca. 6.5 to ca. 7.5. Suitable phenol/formaldehyde resins are obtainable, for example, under the name of Resin XR 14277 A (manufacturer: CECA/ELF-Atochem). This product is an aqueous emulsion of a reactive phenolic resin with a low free formaldehyde content (less than 0.1%). It is a milky, white to slightly yellowish product with a viscosity of 60 to 80 poises and a pH value of 7 to 7.5 for a solids content of 49 to 52% by weight.

Other suitable crosslinker resins are crosslinker resins of the HRJ and SP type (for example SP-8025) marketed by Schenectady International, more particularly the following resins:
HRJ-11112 (terpene/phenol base) with a Brookfield viscosity of 300 to 750, a particle size of about 0.5 to about 3.0 μm, a solids content of about 39 to about 47% and a pH value of about 9 to 10 and
HRJ-10416 (alkyd/phenol base) with a Brookfield viscosity of 1200 to 2750, a particle size of about 1.0 to about 5.0 μm, a solids content of about 51 to about 57% and a pH value of about 4.5 to 6.5.

Other suitable crosslinker resins are based on hydroxymethyl-substituted imidazolidinones, such as 1,3-dimethylol-4,5-dihydroxyimidazolidinone (4,5-dihydroxy-N,N′-dimethylolethyleneurea), hydroxymethyl-substituted pyrimidinones or hydroxymethyl-substituted triazinones or self-condensation products thereof or mixed condensates of two or more of the compounds mentioned or a mixture of two or more of the compounds mentioned. Crosslinker resins of the type in question are commercially available, for example, under the names of Fixapret, Stabitex, Permafresh, Sarcoset, Sumitex, Prox, Knittex, Cassurit, Neuperm or Depremol.

In another embodiment of the present invention, compounds of the Fixapret series, for example Fixapret C-PX, Fixapret COC, Fixapret CP 40 IGD, Fixapret CPK IGD, Fixapret CPNS IGD, Fixapret CP IGD or Fixapret CPN IGD, are used as crosslinker resins. The compounds mentioned are normally used in the form of aqueous emulsions or solutions with a solids content of about 30 to about 50% by weight.

Fixapret C-PX is a polycondensation product of glyoxal/urea/formal-dehyde (dimethyl glyoxal urein) in water with a pH value of 8.0 to 8.5, a solids content of 40 to 42% by weight, a free formaldehyde content of less than 1.1% by weight, a density of 1.03 to 1.06 g/cm³ and an Apha color value of at most 50 which does not cause any precipitation in the presence of MgCl.

Other suitable crosslinker resins are commercially obtainable in the product series marketed, for example, under the name of Stabitex (manufacturer: BASF). Basically, any of the products marketed under the above-mentioned name may be used. In a preferred embodiment of the invention, however, Stabitex ZF or Stabitex GFA is used as the crosslinker resin. The compounds mentioned are normally used as aqueous emulsions or solutions with a solids content of from about 30 to about 50% by weight.

The polymer dispersions according to the invention may contain the crosslinker resins in a quantity of 0 to ca. 5% by weight, for example in a quantity of 0.05 to ca. 4% by weight or 0.1 to ca. 3% by weight.

In another preferred embodiment of the invention, a polymer dispersion according to the invention may also contain an ionic surfactant or a mixture of two or more ionic surfactants. In another preferred embodiment of the invention, these ionic surfactants have a molecular weight of less than about 600.

Anionic, cationic or ampholytic surfactants or mixtures of two or more thereof may be present. Examples of suitable anionic surfactants are alkyl sulfates, particularly those with a chain length of ca. 8 to ca. 18 carbon atoms, alkyl and alkaryl ether sulfates containing ca. 8 to ca. 18 carbon atoms in the hydrophobic part and 1 to ca. 10 ethylene oxide (EO) or propylene oxide (PO) units or a mixture thereof in the hydrophilic part of the molecule, sulfonates, more particularly alkyl sulfonates containing ca. 8 to ca. 18 carbon atoms, alkyl aryl sulfonates containing ca. 8 to ca. 18 carbon atoms, taurides, esters and semiesters of sulfosuccinic acid with monohydric alcohols or alkylphenols containing 4 to about 15 carbon atoms which may optionally be ethoxylated with 1 to about 20 EO units, alkali metal and ammonium salts of carboxylic acids, for example of fatty acids or resin acids containing ca. 8 to ca. 32 carbon atoms or mixtures thereof, phosphoric acid partial esters and alkali metal and ammonium salts thereof.

In a preferred embodiment of the invention, a polymer dispersion according to the invention contains alkyl and alkaryl phosphates containing ca. 8 to ca. 22 carbon atoms in the organic residue, alkylether or alkaryl ether phosphates containing ca. 8 to ca. 22 carbon atoms in the alkyl or alkaryl group and 1 to ca. 10 EO units as anionic surfactants.

Examples of cationic surfactants are salts of primary, secondary or tertiary fatty amines containing about 8 to about 24 carbon atoms with acetic acid, sulfuric acid, hydrochloric acid or phosphoric acids, quaternary alkyl and alkylbenzene ammonium salts, particularly those of which the alkyl groups contain about 6 to about 24 carbon atoms, especially the halides, sulfates, phosphates or acetates, or mixtures of two or more thereof, alkyl pyridinium, alkyl imidazolinium or alkyl oxazolidinium salts, particularly those of which the alkyl chain contains up to about 18 carbon atoms, for example the halides, sulfates, phosphates or acetates or mixtures of two or more thereof.

Examples of ampholytic surfactants are long-chain substituted amino acids, such as N-alkyl di(aminoethyl)glycine or N-alkyl-2-aminopropionic acid salts, betaines, such as N-(3-acylamidopropyl)-N,N-dimethyl ammonium salts with a C₈₋₁₈ acyl group or alkyl imidazolium betaines.

Another preferred embodiment of the present invention is characterized by the use of the following anionic surfactants; the alkali metal salts, more particularly the Na salt, of C_{12/14} fatty alcohol ether sulfates, alkylphenol ether sulfates, more particularly alkali metal or ammonium salts thereof, sodium n-dodecyl sulfate, dipotassium oleic acid sulfonate (C₁₈), sodium n-alkyl-(C₁₀₋₁₃)-benzenesulfonate, sodium 2-ethylhexyl sulfate, ammonium lauryl sulfate (C_{8/14}), sodium lauryl sulfate (C_{12/14}), sodium lauryl sulfate (C_{12/18}), sodium cetyl stearyl sulfate (C_{16/18}), sodium oleyl cetyl sulfate (C_{16/18}), sulfosuccinic acid monoester disodium salt, fatty alcohol sulfosuccinate disodium salt, dialkyl sulfosuccinate sodium salt or disodium sulfosuccinamate or mixtures of two or more thereof.

Where the polymer dispersion according to the invention contains ionic surfactants, they are preferably present in a quantity of up to ca. 1% by weight or less, for example up to ca. 0.8% by weight or ca. 0.5% by weight or less, based on the dispersion as a whole. Relatively small quantities of ionic surfactant, for example up to ca. 0.2% by weight or less, for example ca. 0.1% by weight, 0.05% by weight or 0.02% by weight, may also be present.

In another preferred embodiment, the filler-containing polymer dispersion may contain at least one nonionic surfactant with a molecular weight of less than about 600.

Examples of nonionic surfactants are alkyl polyglycol ethers, preferably those containing ca. 8 to ca. 20 EO units and alkyl groups with ca. 8 to ca. 20 carbon atoms, alkylaryl polyglycol ethers, preferably those containing ca. 8 to ca. 40 EO units and ca. 8 to ca. 20 carbon atoms in the alkyl or aryl groups, ethylene oxide/propylene oxide (EO/PO) block copolymers, preferably those containing ca. 8 to ca. 40 EO units or PO units, addition products of alkyl amines containing alkyl groups with ca. 8 to ca. 22 carbon atoms onto ethylene oxide or propylene oxide, fatty and resin acids containing ca. 6 to ca. 32 carbon atoms, alkyl polyglycosides with linear or branched, saturated or unsaturated alkyl groups containing on average ca. 8 to ca. 24 carbon atoms and an oligoglycoside group containing ca. 1 to ca. 10 hexose or pentose units on average or mixtures of two or more thereof, natural substances and derivatives thereof, such as lecithin, lanolin or sarcosine, linear organo(poly)siloxanes containing polar groups, more particularly those containing alkoxy groups with up to ca. 10 carbon atoms and up to ca. 20 EO or PO groups.

Suitable nonionic surfactants are, for example, nonylphenol ethoxylates, octylphenol ethoxylates, C_{12/14} fatty alcohol ethoxylates, oleyl cetyl ethoxylates, C_{16/18} fatty alcohol ethoxylates, cetyl stearyl ethoxylates, ethoxylated triglycerides, sorbitan monolaurate, sorbitan monooleate, sorbitan-20EO-monooleate, sorbitan-20EO-monostearate or a mixture of two or more thereof.

In another preferred embodiment of the present invention, the dispersion according to the invention contains—for example in addition to or instead of a buffer system—one or more compounds capable of reacting with a strong mineral acid such as can be released, for example, during the use of the acidic metal salts for the purposes of the present invention which are neutralized in the process. Suitable compounds of this type are, for example, amines which can be protonated by reaction with a mineral acid. Suitable amines are, for example, primary, secondary or tertiary amines which may optionally contain one or more functional groups. Amines with one or more OH functionalities, for example ethanolamine, diethanolamine or more particularly triethanolamine, are particularly suitable. Compounds containing at least one epoxy group are also suitable for this purpose.

For example, epoxidized natural fats or fatty acids of the type marketed, for example, by Henkel KGaA under the name of Edenol® are particularly suitable for this purpose. For example, the products Edenol D81, Edenol D82 and Edenol D83 which are characterized in the following Table are particularly suitable:

| | Edenol D81 | Edenol D82 | Edenol D83 |
|---|---|---|---|
| Oxirane content | 6.3-7.0% | 6.5-7.0 | 6.5-7.0% |
| Acid point | 0.0-0.5 | 0.0-0.3 | 0.0-0.3 |
| Iodine value | 0.0-5 | 0.0-2.5 | 0.0-2.5 |
| Refractive index, 20° C. | 1.472-1.474 | 1.472-1.474 | 1.472-1.474 |

In another embodiment of the invention, a polymer dispersion according to the invention contains up to ca. 30% by weight, based on the dispersion as a whole, of additives. The additives include, for example, stabilizers, defoamers, antioxidants, photostabilizers, pigment dispersants, fillers, pH adjusters, plasticizers and the like.

Suitable plasticizers are, for example, esters, such as abietic acid ester, adipic acid ester, azelaic acid ester, benzoic acid ester, butyric acid ester, acetic acid ester, esters of higher fatty acids containing ca. 8 to ca. 44 carbon atoms, esters of OH-functional or epoxidized fatty acids, fatty acid esters and fats, glycolic acid esters, phosphoric acid esters, phthalic acid esters, linear or branched alcohols containing 1 to 12 carbon atoms, propionic acid esters, sebacic acid esters, sulfonic acid esters, thiobutyric acid esters, trimellitic acid esters, citric acid esters and mixtures of two or more thereof. The asymmetrical esters of dibasic aliphatic dicarboxylic acids, for example the esterification product of adipic acid monooctyl ester with 2-ethyl hexanol (Edenol DOA, a product of Henkel KGaA, Düsseldorf), are particularly suitable.

Other suitable plasticizers are the pure or mixed ethers of monohydric, linear or branched C₄₋₁₆ alcohols or mixtures of two or more different ethers of such alcohols, for example dioctyl ethers (obtainable as Cetiol OE from Henkel KGaA, Düsseldorf).

In another preferred embodiment, end-capped polyethylene glycols, for example polyethylene or polypropylene glycol di-C₁₋₄-alkyl ethers, more particularly the dimethyl or diethyl ethers of diethylene glycol or dipropylene glycol, and mixtures of two or more thereof, are used as plasticizers.

If it is to be used as an adhesive, the preparation according to the invention may contain up to ca. 10% by weight of typical tackifiers. Suitable tackifiers are, for example, resins, terpene oligomers, coumarone/indene resins, aliphatic petrochemical resins and modified phenolic resins.

The preparation according to the invention may contain up to ca. 2% by weight and preferably ca. 1% by weight of UV stabilizers. Particularly suitable UV stabilizers are the so-called hindered amine light stabilizers (HALS).

In another preferred embodiment of the invention, the polymer dispersion contains ca.
30 to 70% by weight of a water-dispersible polymer obtainable in particular by emulsion polymerization or a mixture of two or more thereof,
0.5 to 15% by weight of a protective colloid or a mixture of two or more protective colloids,
0 to 0.5% by weight of a nonionic surfactant,
0 to 0.1% by weight of an ionic surfactant,
0 to 30% by weight of other additives and
one of the above-mentioned quantities of marking elements and
water to 100% by weight.

Basically, a polymer dispersion according to the invention may be produced in any way by mixing a dispersion of a water-dispersible polymer or a mixture of two or more such polymers in water or a water-containing environment with one of the elements mentioned above, more particularly in its salt form.

Accordingly, the present invention also relates to a process for the production of a polymer dispersion according to the invention in which at least two elements selected from the group consisting of Li, Ba, Sr, B, Co, Cu, Mn. Mo, Ni, Ag, Pb, Zn, W, La, Ce or Sn or at least two salts selected from the group of salts of the elements Li, Ba, Sr, B, Co, Cu, Mn, Mo, Ni, Ag, Pb, Zn, W, La, Ce or Sn, at least two of the salts containing a different ion selected from the group consisting of the ions of the elements Li, Ba, Sr, B, Co, Cu, Mn, Mo, Ni, Ag, Pb, Zn, W, La, Ce or Sn, are added to a dispersion of a water-dispersible polymer and the total quantity of elements or ions of the elements selected from the above-mentioned group amounts to at least 10 ppm, based on the dispersion as a whole.

In a preferred embodiment of the present invention, the polymer dispersion according to the invention is prepared by emulsion polymerization. In the context of the present invention, “emulsion polymerization” is understood to be a polymerization process in which monomers insoluble or poorly soluble in water are emulsified in water using emulsifiers and polymerized using water-soluble initiators. Suitable emulsion polymerization processes are described, for example, in Comprehensive Polymer Chemistry, 4, 171-218, Elias (5th Edition), 2, 93 et seq; in Encyclopaedia of Polymer Science and Engineering, 12, 512 et seq and in Encyclopaedia of Polymer Science and Technology, 5, 801 et seq. Other suitable references are known, for example, from the reference books known to the expert, Ullmann's Enzyklopädie der technischen Chemie, Houben-Weyl (E20, 218-268) or Kirk-Othmer. Reference is hereby expressly made to the cited literature references, the disclosures of those references being regarded as part of the disclosure of the present specification.

Polymerization initiators suitable for use in the production of the polymer dispersions according to the invention are both water-soluble and oil-soluble polymerization initiators. Particularly suitable polymerization initiators are water-soluble initiators, such as tert.butyl hydroperoxide, sodium peroxodisulfate, peroxodisulfuric acid, cumene hydroperoxide, azo compounds, such as diazoisobutyrodinitrile or benzoyl peroxide. Redox initiators, i.e. systems consisting of oxidizing and reducing agents, are also suitable. In many cases, water-soluble redox initiators contain transition metals, for example Fe/HO (I), although other basic components, for example the systems peroxysulfates/metabisulfates, peroxysulfates/thiosulfates or peroxides/thiosulfates, may also be used.

In a preferred embodiment of the invention, sodium persulfate, potassium persulfate or ammonium persulfate is used as the polymerization initiator.

According to the invention, the quantity of polymerization initiator used is generally between ca. 0.01 and ca. 0.5% by weight, based on the dispersion as a whole. In a preferred embodiment of the invention, the total amount of polymerization initiator used is between ca. 0.03 and ca. 0.2% by weight, for example between ca. 0.05 and ca. 0.15% by weight.

According to the invention, the total quantity of polymerization initiator may be present in the reaction mixture at the beginning of the polymerization process. In a preferred embodiment of the invention, however, the polymerization initiator is added in at least two batches at different stages of the polymerization reaction. For example, part of the total quantity of polymerization initiator may be added before the monomer(s), the remainder being added in portions or continuously during or after addition of the monomer(s).

The elements or salts used in accordance with the invention for marking the polymer dispersion may also be added before, during or after the polymerization reaction. According to the invention, corresponding adhesives may also be formulated, for example, as two-pack systems, mixing of the resin and hardener being undertaken by the user. In cases such as these, the element used for marking may be present in the hardener.

In a preferred embodiment, however, the corresponding salts—preferably in dissolved form—are added to the reaction mixture after the polymerization reaction and are homogeneously distributed in the polymer dispersion by suitable homogenizing processes, for example by stirring. In a preferred embodiment, the salts used for marking the polymer dispersions are completely soluble therein.

Accordingly, the present invention also relates to a process for the production of a polymer dispersion according to the invention in which at least two elements selected from the group consisting of Li, Ba, Sr, B, Co, Cu, Mn, Mo, Ni, Ag, Pb, Zn, W, La, Ce or Sn or at least two salts selected from the group of salts of the elements Li, Ba, Sr, B, Co, Cu, Mn, Mo, Ni, Ag, Pb, Zn, W, La, Ce or Sn, at least two of the salts containing a different ion selected from the group consisting of the ions of the elements Li, Ba, Sr, B, Co, Cu, Mn, Mo, Ni, Ag, Pb, Zn, W, La, Ce or Sn, are added before, during or after an emulsion polymerization for the production of a polymer obtainable by emulsion polymerization and the total quantity of added elements or ions of the elements selected from the above-mentioned group amounts to at least 10 ppm, based on the dispersion as a whole.

Where their presence in a polymer dispersion according to the invention is desired, the other constituents present in the polymer dispersion, for example protective colloids, surfactants and additives, may be added before, during or after the emulsion polymerization.

If their addition is intended or desired, the crosslinker resins may also be added before, during or after the emulsion polymerization. They may be added, for example, shortly before or at the beginning of the polymerization reaction. It has been found that the addition of the crosslinker resin before or during the polymerization process leads to products which have a longer shelf life at high temperatures, for example at ca. 30 to ca. 50° C., than products where the crosslinker resin was added after the polymerization reaction.

In a preferred embodiment of the present invention, 1,3-dimethylol-4,5-dihydroxyimidazozlidinone (4,5-dihydroxy-N,N′-dimethylolethylene urea) or dihydroxymethyl ethylene urea, dihydroxymethyl propylene urea or dihydroxymethyl urone or thio derivatives thereof either in the form of respective compounds mentioned, self-condensation products thereof or mixed condensates of two or more of the compounds mentioned or condensates may be added as the crosslinker resins.

In another preferred embodiment of the invention, emulsion polymerization is carried out in the presence of a protective colloid or a mixture of two or more protective colloids.

The polymer dispersions according to the invention are suitable for the surface coating or bonding of like or different substrates, substrates with a smooth surface and substrates with rough or porous surfaces being coatable or bondable with the polymer dispersions. Suitable substrates are, for example, natural or artificial substrates, for example floor coverings, wall coverings, felt, wood, wood materials and the like. In a preferred embodiment of the present invention, the polymer dispersions according to the invention are used for the coating or bonding of substrates based on natural raw materials, for example for the bonding of wood, paper or paperboard.

Accordingly, the present invention also relates to the use of the polymer dispersions according to the invention in adhesives or surface coating compositions, such as lacquers, emulsion paints, glues, adhesives or other surface coatings.

The present invention therefore also relates to an adhesive or a surface coating composition containing a polymer dispersion according to the invention or a polymer dispersion produced by the process according to the invention.

The present invention also relates to the use of a mixture of at least two elements selected from the group consisting of Li, Ba, Sr, B, Co, Cu, Mn, Mo, Ni, Ag, Pb, Zn, W, La, Ce or Sn or at least two salts selected from the group of salts of the elements Li, Ba, Sr, B, Co, Cu, Mn, Mo, Ni, Ag, Pb, Zn, W, La, Ce or Sn, at least two of the water-soluble salts containing a different ion selected from the group consisting of the ions of Li, Ba, Sr, B, Co, Cu, Mn, Mo, Ni, Ag, Pb, Zn, W, La, Ce or Sn, for marking dispersion adhesives.

The dispersions according to the invention may be analyzed for their content of the above-mentioned elements by analysis techniques and thus identified. Accordingly, the present invention also relates to a process for identifying an adhesive in which a sample of the adhesive is taken and the adhesive is analyzed for its content of elements selected from the group consisting of Li, Ba, Sr, B, Co, Cu, Mn, Mo, Ni, Ag, Pb, Zn, W, La, Ce or Sn.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

The invention is illustrated by the following Examples.

### EXAMPLES

Production of the Marked Adhesives:

### Example 1

30 grams lithium chloride were dissolved in 70 grams distilled water. 0.282 gram of this salt solution was then stirred into 100 grams polyvinyl acetate dispersion. 10 grams tin(II) sulfate were then dissolved in 90 grams distilled water. 0.083 g of this solution was added to the adhesive already marked with Li and homogeneously stirred in. The lithium concentration, based on the weight of the dispersion as a whole, was thus 138 ppm and the concentration of Sn ions, based on the weight of the dispersion as a whole, 46 ppm. The ratio by weight of Li to tin was 3:1. The marked adhesive thus obtained was then used to glue solid wood. To this end, two solid boards measuring 40 cm×12.5 cm×0.5 cm were glued to one another. The moisture content of the woods used was between 8 and 9%. The adhesive was applied to one side in a quantity of 150 g/m². After the boards had been joined, they were pressed together for 30 minutes at room temperature under a pressure of 0.5 N/mm². Gluing was carried out to practical standards.

The test specimens were then trimmed on a circular saw and uniformly planed on both sides with a thickness plane, 3.5 mm being planed off from each side. The test specimen obtained was 3 mm thick with a adhesive joint in the middle. For analysis preparation, 0.2 mm thick shavings were planed off with a hand plane on the narrow side parallel to the grain. The specimens thus obtained were pulped and then analyzed by ICP-OES.

In a blank test, the test specimen was glued and treated under the same conditions, except that the adhesive was used without any marking.

Analysis results for Example 1 in mg/kg sample (ppm)

| | Blank sample | Marked sample |
|---|---|---|
| Li | <1 | 9 |
| Sn | <1 | 3 |

The adhesive was identified clearly and in the ratio added.

### Example 2

30 grams lithium chloride were dissolved in 70 grams distilled water. 0.282 gram of this salt solution was then stirred into 100 grams polyvinyl acetate dispersion. 10 grams strontium chloride hexahydrate were then dissolved in 90 grams distilled water. 0.200 g of this solution was then added to the adhesive already marked with Li and homogeneously stirred in. The lithium concentration, based on the weight of the dispersion as a whole, was thus 138 ppm and the Sr concentration, based on the weight of the dispersion as a whole, 50 ppm. The ratio by weight of Li to Sr was 2.76:1. The marked adhesive thus obtained was then used to glue solid wood as described above. Analysis samples were then prepared, again in the same way as described above.

Analysis results for Example 2 in mg/kg sample (ppm)

| | Blank sample | Marked sample |
|---|---|---|
| Li | <1 | 9 |
| Sn | <1 | 3 |

The adhesive was identified clearly and in the ratio added.

### Example 3

30 grams lithium chloride were dissolved in 70 grams distilled water. 0.282 gram of this salt solution was then stirred into 100 grams polyvinyl acetate dispersion. 10 grams strontium chloride hexahydrate were then dissolved in 90 grams distilled water. 0.100 g of this solution was then added to the adhesive already marked with Li and homogeneously stirred in. The lithium concentration, based on the weight of the dispersion as a whole, was thus 138 ppm and the Sr concentration, based on the weight of the dispersion as a whole, 25 ppm. The ratio by weight of Li to Sr was 5.5:1. The marked adhesive thus obtained was then used to glue solid wood as described above. Analysis samples were then prepared, again in the same way as described above.

Analysis results for Example 3 in mg/kg sample (ppm)

| | Blank sample | Marked sample |
|---|---|---|
| Li | <1 | 10 |
| Sn | <1 | 2 |

The adhesive was identified clearly and in the ratio added.

To rule out any possibility of the result changing with time, the test specimens were exposed to outdoor weathering for 6 months and then prepared and analyzed in the same way as before.

Result after weathering:

Analysis results in mg/kg sample (ppm)

| | Example 1 | Example 2 | Example 3 |
|---|---|---|---|
| Li | 9 | 9 | 10 |
| Sn | 3 | | |
| Sr | | 3 | 2 |

No effects attributable to weathering or ageing could be detected.

The following substances were used.
Mowilith LDL 2555 W, polyvinyl acetate dispersion from Celanese, solids content ca. 50%
Lithium chloride, 99%, from Merck
Tin(II) sulfate from Fluka
Strontium chloride hexahydrate from Fluka

The marked adhesives were tested for their properties and compared with the unmarked basic dispersion. The marked adhesives were also subjected to a storage test. The results of the storage test are set out in the following Table.

| | Blank | | | |
|---|---|---|---|---|
| Test | specimen | Example 1 | Example 2 | Example 3 |
| EN 14257 | 7.4 N/mm² | 7.3 N/mm² | 7.4 N/mm² | 7.3 N/mm² |
| EN 204 D3 | 2.3 N/mm² | 2.4 N/mm² | 2.3 N/mm² | 2.2 N/mm² |
| Open time | 10 mins | 10 mins. | 10 mins. | 10 mins. |
| Viscosity | 12,600 mPas | 12,500 mPas | 12,400 mPas | 12,500 mPas |
| pH value | 3.0 | 2.9 | 3.0 | 3.0 |
| MFT | 4° C. | 4° C. | 4° C. | 4° C. |
| CTS | 2850 N | 2800 N | 2900 N | 2750 N |

No significant difference in properties could be detected. Any slight differences lie within the range of accuracy of the methods used.

After heat ageing (storage test), the following properties were determined:

| | Blank | | | |
|---|---|---|---|---|
| Test | specimen | Example 1 | Example 2 | Example 3 |
| EN 14257 | 7.5 N/mm² | 7.4 N/mm² | 7.4 N/mm² | 7.5 N/mm² |
| EN 204 D3 | 2.1 N/mm² | 2.1 N/mm² | 2.2 N/mm² | 2.2 N/mm² |
| Open time | 10 mins | 11 mins. | 11 mins. | 10 mins. |
| Viscosity | 13,900 mPas | 13,600 mPas | 13,400 mPas | 13,800 mPas |
| pH value | 2.8 | 2.8 | 2.9 | 2.8 |
| MFT | 2° C. | 2° C. | 2° C. | 2° C. |
| CTS | 3150 N | 3100 N | 2950 N | 3200 N |

The results show that there are only slight changes in the properties of the adhesive. These changes are known to the expert and are regarded as normal and acceptable. Any slight differences lie within the range of accuracy of the methods used.

Test Methods:

Determination of open time:

The measurement was carried out on conditioned, unsteamed solid beech (Fagus sylvatica) with a wood moisture of 8-10% and an adhesive application of 150μ and 200μ.

The measurement was carried out under constant climatic conditions at 23° C./50% relative humidity. The adhesive to be tested—stored at 23° C.—is applied with a 150μ and 200μ spiral doctor. The adhesive film is tested for skin formation at 1-minute intervals. If skin formation is visible, a minute is deducted from the value determined. An average value of 150 and 200 μm is formed. The result is expressed in minutes.

Determination of heat resistance: DIN EN 14527, November 2001 Draft

Determination of adhesive strength of linear bonds by tensile testing in heat (watt 91). Result expressed in N/mm².

Determination of water resistance: DIN EN 204 September 2001 (EN 204:2001)

Classification of thermoplastic wood adhesives for non-load-bearing applications. Stress Group D3 was tested (minimum requirement: 2.0 N/mm²). The result is expressed in N/mm².

Determination of viscosity: Brookfield Digital Viscosimeter RTV DV-II at 23° C. Viscosity measured to EN ISO 2555 (spindle 6, 20 r.p.m., 23° C.). The result is expressed in mPas.

Determination of pH: pH measured to DIN 53785/ISO 1148. Microprocessor pH meter pH 537 WTW pH meter CG 818, Schott Einstabmesskette (glass electrode) Type N 61. The result is dimensionless.

Determination of MFT: MFT to DIN 53787/ISO 2115. The result in expressed in ° C.

Determination of early cross tensile strength (CTS). The test was carried out on butt-glued, solid, unsteamed and planed beech (Fagus sylvatica) with a wood moisture of 8-9% which had been stored at 23° C./50% relative humidity. To this end, 5 pieces of beech wood measuring 20 cm long×4 cm wide×2 cm thick were glued to one another on the narrow sides so that a total surface area of 20×20 cm was formed. The individual beechwood pieces were cut obliquely at an angle of 200 to a depth of 24 mm at their head ends so that, when the individual pieces were glued, an equal-sided V cutout with a total angle of both sides of 40°, a depth of 24 mm and a broad shoulder of 18.5 mm was formed. A 2 cm wide V cutout was thus formed at each adhesive joint.

Before the test, the test woods were conditioned for at least 2 weeks under constant conditions (23° C./50% relative humidity) to ensure that an equalizing wood moisture of 8 to 9% was established. The pieces of wood were glued under defined climatic conditions of 23° C./50% relative humidity, the adhesive itself also having a temperature of 23° C. The adhesive was applied on one side with a 200μ spiral doctor. The pieces were joined after an airing time of 1 minute following application of the adhesive. A pressure of 0.3 to 0.5 N/mm² was applied. After pressing for 20 minutes, the pressure was released and the test was carried out immediately afterwards. The measurement itself was carried out in a mechanical tensile testing machine to which a force reversal mechanism was fitted to enable the machine to be converted from a tensile testing machine into a compression testing machine. To split the test specimens at the adhesive joint, a solid polished aluminium wedge with a flank angle of 20° was mounted on the force transducer, fitting exactly into the notch of the test specimens without touching the bottom of the flank. The aluminium wedge was then inserted into the notch of the wood test specimens at a constant rate of advance of 50 mm/min. and the force in N required to split the adhesive joint was determined. The four adhesive joints were split at intervals of 10 seconds. The arithmetic mean of the four measured values of the four adhesive joints was then calculated. The result is expressed in N.

Shelf life test. The adhesive to be tested is stored for 3 months at 40±1° C. in a 250 ml glass bottle with a stopper impermeable to water vapor. The properties of the adhesive were then determined.

What is claimed is:

1. A polymer dispersion comprising water, at least one water-dispersible polymer and at least two ions or elements selected from the group consisting of Li, Ba, Sr, B, Co, Cu, Mn, Mo, Ni, Ag, Pb, Zn, W, La, Ce and Sn or salts thereof, wherein the total quantity of the selected elements or ions in the dispersion is at least 10 ppm.

2. The polymer dispersion of claim 1, wherein the water-dispersible polymer comprises a polymer produced by emulsion polymerization.

3. The polymer dispersion of claim 1, comprising two different water-soluble salts of the elements Li, Ba, Sr, B, Mo, Ni, Ag, Zn, La, Ce and Sn, each of the salts containing a different element selected from the group consisting of Li, Ba, Sr, B, Mo, Ni, Ag, Zn, La, Ce and Sn.

4. The polymer dispersion of claim 1, comprising at least two of the salts in a ratio of 1:100 to 100:1.

5. The polymer dispersion of claim 1, comprising at least 30% by weight of a polymer produced by emulsion polymerization.

6. The polymer dispersion of claim 1, wherein the water-dispersible polymer comprises polyvinyl acetate or a copolymer of vinyl acetate.

7. A process for the production of a polymer dispersion, comprising the steps of selecting at least two elements from the group consisting of Li, Ba, Sr, B, Co, Cu, Mn, Mo, Ni, Ag, Pb, Zn, W, La, Ce and Sn or salts thereof and adding to a dispersion of a water-dispersible polymer at least 10 ppm, based on the dispersion as a whole, of the two elements or salts thereof.

8. A process for the production of a polymer dispersion comprising the

8. A process for the production of a polymer dispersion comprising the steps of selecting at least two elements from the group consisting of Li, Ba, Sr, B, Co, Cu, Mn, Mo, Ni, Ag, Pb, Zn, W, La, Ce and Sn or salts thereof and adding at least 10 ppm of the selected elements or salts before, during or after an emulsion polymerization step.

9. An adhesive or coating composition comprising the polymer dispersion of claim 1.

10. A process for identifying an adhesive in which a sample of the adhesive is taken and the adhesive is analyzed for its content of ions or elements selected from the group consisting of Li, Ba, Sr, B, Co, Cu, Mn, Mo, Ni, Ag, Pb, Zn, W, La, Ce or Sn.
